(19) United States
(12) Patent Application Publication
(10) Pub. No.: US 2002/0057822 A1
(43) Pub. Date: May 16, 2002

(54) PLANAR MAGNETIC ACOUSTIC TRANSDUCER DIAPHRAGMS WITH PASSIVE AREAS FOR MODAL CONTROL

(76) Inventors: MOHAMMAD KERMANI, VANCOUVER (CA); MICHAEL LEDUC, VANCOUVER (CA); THOMAS ZELINKA, VANCOUVER (CA)

Correspondence Address: DOWELL & DOWELL, P.C., 1215 JEFFERSON DAVIS HWY, SUITE 309, ARLINGTON, VA, 22202

(21) Appl. No.: 09/099,465

(22) Filed: Jun. 18, 1998

(51) Int. Cl. H04R 1/00; H04R 11/02

(52) U.S. Cl. 381/427

(57) ABSTRACT

Planar magnetic acoustic transducer diaphragms are formed from an electrical non-conducting membrane and metallic layer laminate by selectively removing portions of the metallic layer to create at least one electrical conductor circuit pattern and at least one passive metallic area both of which are of a predetermined size and configuration to balance modal behavior of the diaphragms when in use.

### CROSS REFERENCES TO RELATED APPLICATIONS

None

### STATEMENT AS TO RIGHTS TO INVENTIONS MADE UNDER FEDERALLY SPONSORED RESEARCH AND DEVELOPMENT

None

### BACKGROUND OF THE INVENTION

1. Field of the Invention

The present invention is directed to diaphragms of the type which are utilized in planar magnetic acoustic transducers and more particularly to diaphragms formed of a laminate of a and a metallic layer wherein portions of the metallic layer are selectively removed to form both an electrical circuit on at least one surface of the membrane and at least one passive area or mass which is spaced from the electrical circuit so as to provide for control over modal response of the diaphragms when they are vibrated.

2. History of the Related Art

Planar magnetic acoustic transducer diaphragms are formed utilizing a thin film to which an electrical circuit is applied in such a manner that, when a diaphragm is mounted within a support frame having an open central area, the diaphragm is caused to vibrate in response to an interaction between current flowing through the electrical circuit and a magnetic field generated by a magnetic source which is mounted adjacent to the diaphragm. In most conventional prior art planar magnetic acoustic transducers, the electrical circuits are applied generally uniformly across the entire “active” surface area of the diaphragm. The active surface area is that area of the diaphragm which is spaced inwardly from the perimeter of the frame which supports the diaphragm relative to the magnetic source and is the portion of the diaphragm which is vibrated when the transducer is in use. In some acoustical transducers the magnetic sources are formed of permanent magnets which are mounted on a single side of the diaphragm. In other transducers the permanent magnets may be mounted in opposing or offset relationship on opposite sides of the diaphragm to thereby provide a push-pull action when a current is generated through the electrical circuit associated with the diaphragm.

One of the major drawbacks with conventional planar magnetic transducers is the high cost associated with manufacturing and especially where the diaphragms are driven substantially across their entire active surface area. Research has been conducted with respect to reducing the actual “driven” surface area of the diaphragm. The driven surface area is that portion of the diaphragm which includes an electrical conductor which, in use, is placed within a magnetic field of a magnetic source positioned adjacent to the diaphragm. To reduce manufacturing costs, there is a need to limit the number of magnets or magnetic sources which must be utilized to effect an adequate tonal or frequency response of the diaphragm, however, as the undriven area of a diaphragm increases relative to the driven areas, there results greater modal activity.

In the prior art, there are a number of instances wherein the undriven area of an acoustical transducer diaphragm has been provided with stiffening elements. In U.S. Pat. No. 3,922,503 to Tabuchi et al. a circular diaphragm having a radial conductor pattern is disclosed wherein additional metal parts are secured to the diaphragm spaced from the conductor pattern in order to provide greater mass. The addition of the metal parts requires a further processing step which significantly increases the production cost. In U.S. Pat. No. 4,264,789 to Kaizu et al., a metallic layer is placed around the periphery of a voice coil in order to dissipate heat from the area of the voice coil, however, the metallic layer is not provided for purposes of controlling a modal response of the diaphragm when in use.

U.S. Pat. No. 4,924,504 to Burton discloses the use of thin aluminum strips of variable widths fixed to a diaphragm immediately adjacent opposite sides of a linear coil. As with the patent to Tabuchi et al., the processing of the diaphragm requires an additional step wherein aluminum strips are fixed to the diaphragm on opposite sides of the electrical trace pattern.

In German Patent 4,215,519 to Hubert, passive sensor conductors are placed on the diaphragm for purposes of feedback control. The passive conductor are placed in a region of maximum magnetic field and are oriented in an annular pattern.

### SUMMARY OF THE INVENTION

The present invention is directed to diaphragms for planar magnetic acoustical transducers and their method of manufacture wherein the diaphragms include passive strips or areas which are preferably metallic and formed in spaced relationship with respect to electrical circuit conductor patterns also formed on the surface of the diaphragms. The electrical conductor circuit patterns and the passive areas are formed by selectively removing portions of a metallic layer associated with a laminated diaphragm material which includes at least one electrically non-conducting membrane layer and a metallic layer. In a preferred embodiment, an electrical circuit pattern and at least one passive strip are formed by selectively etching portions of the metallic layer from the membrane layer such that the at least one passive area is positioned relative to the conductor pattern so as to control the modal behavior of the diaphragm when in use.

In another embodiment of the invention, a plurality of passive strips or areas are formed along at least one surface of the membrane layer of the laminate material so as to be generally parallel but spaced from at least two of a plurality of spaced parallel branches defining an electrical circuit pattern. In another embodiment, the passive areas are formed asymmetrically with respect to the spaced branches of the electrical circuit pattern.

In a further embodiment of the present invention, passive areas are formed either symmetrically or asymmetrically relative to the branches of the electrical circuit pattern and are provided between the edges of the diaphragm and the electrical circuit pattern. In each of the embodiments, the configuration and size of the passive strips or areas may be varied across the surface of the diaphragm depending upon a predetermined requirement for mass placement and stiffness which will vary depending upon the electrical circuit pattern. The electrical circuit pattern may include branches having undulated configurations along the edges thereof with passive strips being undulated and spaced intermediate the undulations of the electrical circuit pattern.

In a further embodiment of the present invention, one or more passive strips may extend along substantially the entire length or width of a diaphragm to thereby section the diaphragm into two portions each of which may carry a separate electrical conductor circuit pattern. In this embodiment, each portion of the diaphragm may be selectively utilized to provide an operating response in a different frequency range such that a first portion of the diaphragm provides a wide mid-range response and a second portion of the diaphragm provides response in a high frequency range. In this embodiment, further passive areas may be utilized to provide modal control by changing the mass and stiffness characteristics of either of the portions of the diaphragm depending upon operating parameters.

It is the primary object of the present invention, to provide diaphragms for planar magnetic acoustic transducers which include passive strips or areas which are formed in a predetermined manner by removing portions of a metal layer from a laminate from which the diaphragm is manufactured such that the formation of the electrical circuit pattern associated with the diaphragm and the formation of one or more metallic areas may be performed substantially simultaneously.

It is a further object of the present invention to utilize one or more passive metallic areas which are formed by removing selected portions of a metallic layer from a laminate used to form a diaphragm for an acoustical transducer such that the passive area(s) is utilized to counterbalance an electrical conductor pattern associated with the diaphragm to thereby allow for a smoother or flatter response of the diaphragm when in use.

It is also an object of the present invention, to produce diaphragms for use with electrical acoustic transducers of the planar magnetic type which incorporate metallic passive strips or areas which both stiffen the diaphragms as well as counterbalance the mass associated with an electrical conductor circuit applied to the diaphragms to thereby control modal behavior of the diaphragms to obtain a smoother response in the operating range of the diaphragms.

It is yet a further object of the present invention, to utilize passive metallic areas along a surface of diaphragms used in planar magnetic acoustical transducers which provide a heat radiating surface to dissipate heat away from the diaphragms.

### BRIEF DESCRIPTION OF THE DRAWINGS

The invention will be better understood with reference to the drawings, wherein:

FIG. 1 is a top plan view of a support frame for a diaphragm and magnets of a planar magnetic acoustical transducer using the teachings of the present invention;

FIG. 2 is a side elevational view of the support frame of FIG. 1;

FIG. 3 is a cross-sectional view taken along line 3-3 of FIG. 2;

FIG. 4 is a cross-sectional view taken along line 4-4 of FIG. 3;

FIG. 5 is a top plan view of a first embodiment of diaphragm having an electrical circuit pattern and passive metallic areas formed in accordance with the invention;

FIG. 6 is a top plan view of another embodiment of the invention;

FIG. 7 is a top plan view of a variation of the embodiment shown in FIG. 6;

FIG. 8 is a top plan view of another embodiment of the invention;

FIG. 9 is a top plan view of a further embodiment of the invention;

FIG. 10 is another embodiment of the invention showing two independent electrical circuit patterns; and

FIG. 11 is a perspective illustrational view showing a laminate material from which the embodiments of the invention are formed.

### DESCRIPTION OF THE PREFERRED EMBODIMENTS

With specific reference to FIG. 11 the diaphragms of the present invention are constructed from a laminate 10 including a non-conductive membrane layer 11 having a metallic layer 12 such as an aluminum or copper layer applied to at least one surface of the film. The membrane may be any thin flexible electrically non-conductive material such as paper, cloth, plastics including various polymers and the like. In the prepared embodiment the membrane is a Mylar™ or similar plastic film. In some embodiments, however, a metallic layer 13 may be applied to the opposite surfaces of the membrane for purposes which will be discussed in greater detail hereinafter.

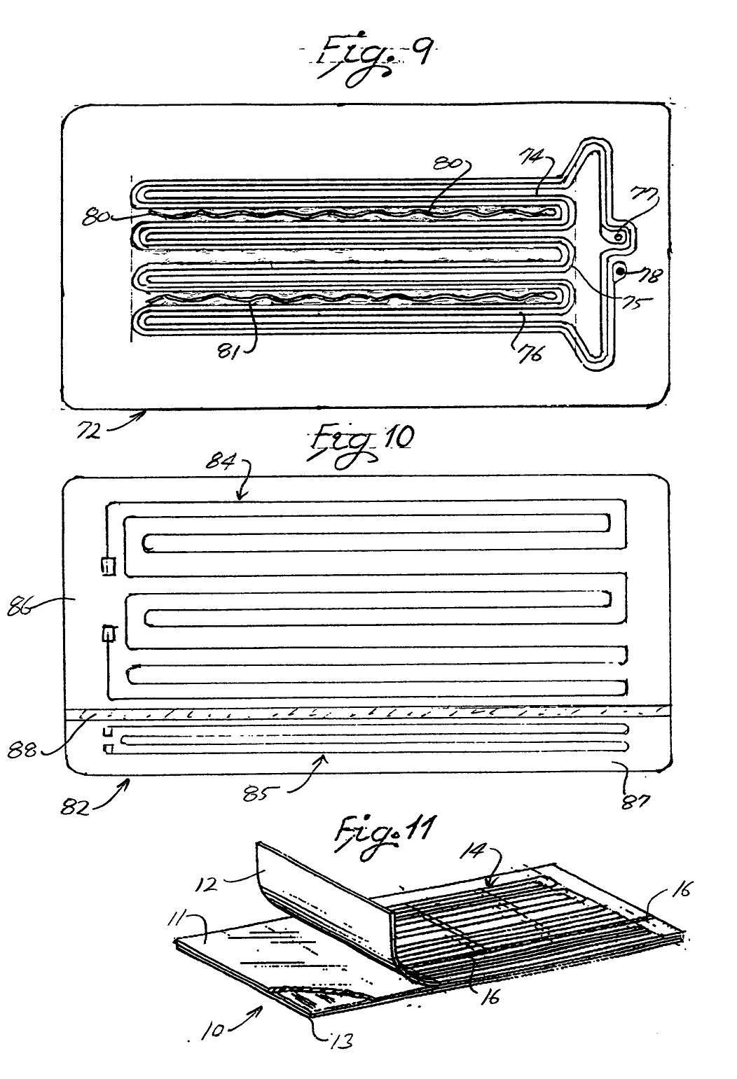

To form an electrical conductor circuit on the diaphragm material, portions of the metallic layer 12 must be selectively removed by subtractive processing of the metallic layer. In one embodiment, the metallic layer 12 is coated such as by printing, screening or otherwise applying a chemical resistant material so as to define a predetermined circuit pattern shown generally at 14 in FIG. 11. After the circuit pattern has been applied on the metallic layer, the material is chemically processed to remove portions of the metallic layer which are not protected by the surface coating thereby leaving a predetermined circuit pattern on the surface of the membrane, such as is shown in FIG. 9. Utilizing the teachings of the present invention, in addition to the electrical circuit pattern, at least one coating pattern 16 is also applied to the metallic layer in space relationship with respect to the coating for the electrical conductor pattern for purposes of forming a passive metallic area on at least one surface of the membrane after the diaphragm material is chemically processed. In some embodiments, where a lower or second metallic layer 13 is applied to the membrane 11, one or more passive metallic areas or masses may also be formed on the lower surface of the film during the subtractive processing.

Although chemical processes such as etching is the preferred manner of removing selected portions of the metallic layer from the laminate from which the diaphragms of the present invention are made, it is also possible that other subtractive processes such as a precision grinding process may be utilized to remove portions of the metallic layer(s) to thereby define both the electrical circuit pattern and the at least one passive strip or area on the surface of the membrane.

Although the subtraction process, such as etching, may result in a relative uniform thickness of the metallic circuit patterns and the one or more metallic passive areas relative to one another, the process may be used to create varying thickness in either or both of the circuit pattern and passive areas to achieve a predetermined mass balancing of a diaphragm. For example, portions or all of the passive areas may be partially etched leaving some of the metallic layer at a reduced thickness or creating passive areas of varying thickness.

As previously noted, the size, configuration, number and spacing of the passive strips or areas will vary depending upon the modal behavior of a diaphragm having a particular circuit pattern. Therefore, when a circuit pattern is modified with respect to the diaphragm, it will be necessary to determine the optimal placement and number of passive areas which are necessary to provide stiffening of the diaphragm and mass counterbalancing of the driven areas of the diaphragm. In the embodiments to be described hereinafter, the passive areas are varied in their size or mass, formation and configuration in order to optimize performance for a diaphragm having a particular size and configuration of electrical conductor pattern formed thereon. The passive metallic areas are formed in spaced relationship with respect to the electrical circuit pattern so as to not interfere with the current flowing through the circuit pattern when the diaphragm is in use.

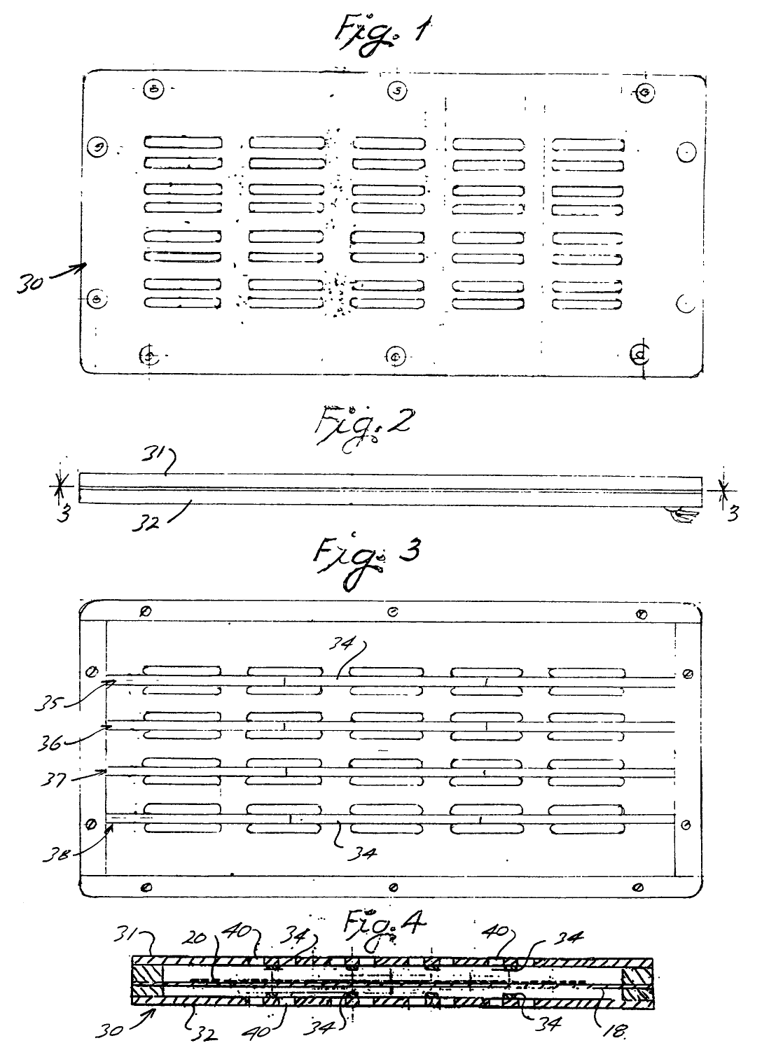

With specific reference to FIG. 5, a top plan view of a first embodiment of the diaphragm formed in accordance with the teachings of the present invention is disclosed. The diaphragm 18 includes an electrical circuit pattern 20 including a plurality of generally parallel branch segments 21-24 which are connected in end-to-end relationship to an input and output 25 and 26, respectively. The electrical input and output are designed to connect to electrical contacts associated with a diaphragm support frame 30, such as shown in drawing FIGS. 1-4. The diaphragm support frame includes opposite frame sections 31 and 32 which are utilized to support magnetic devices which, in the preferred embodiment, are permanent magnets such as shown at 34. The number of permanent magnets may vary depending upon the size and output desired for a particular acoustic transducer. In drawing FIG. 4, four rows 35-38 of permanent magnets are shown in spaced relationship with respect to another with each row including three magnets. The magnets are mounted to the frame sections in such a manner that they are separated by openings 40 through the back plate of the frame sections by way of which sound escapes when a transducer is in use. The magnets are aligned with and equally spaced from and on opposite sides (upper and lower) of each of the branches 21-24 of the electrical circuit pattern 20 when the diaphragm 18 is clamped between the frame sections such that the branches of the electrical pattern are within the magnetic fields created by opposing magnets. In the preferred embodiment, opposing magnets having like poles are equally spaced with respect to the conductor pattern. In some embodiments only a single set of magnets or magnetic drivers are supported on one of the sections of the support frame. In other embodiments the opposing magnets may be offset relative to one another with different poles being oriented toward the electrical circuit pattern. The portion of the diaphragm which is covered by the branches of the electrical pattern and which are within the magnetic field created by the magnets, is referred to as the “driven area” of the active surface of the diaphragm.

As shown in FIG. 5, in addition to forming the electrical circuit pattern, in this embodiment, a plurality of passive metallic strips 36 are disclosed which are oriented on opposite sides and intermediate the branches 21-24 of the electrical circuit pattern. In this embodiment, the passive strips or areas are shown as generally being uniform in configuration and size and are oriented symmetrically and generally parallel with respect to the branches of the electrical pattern. The passive areas are spaced relative to the branches of the electrical circuit and the magnets so as to not interfere with the current flowing through the circuit or the magnetic fields created by the magnets.

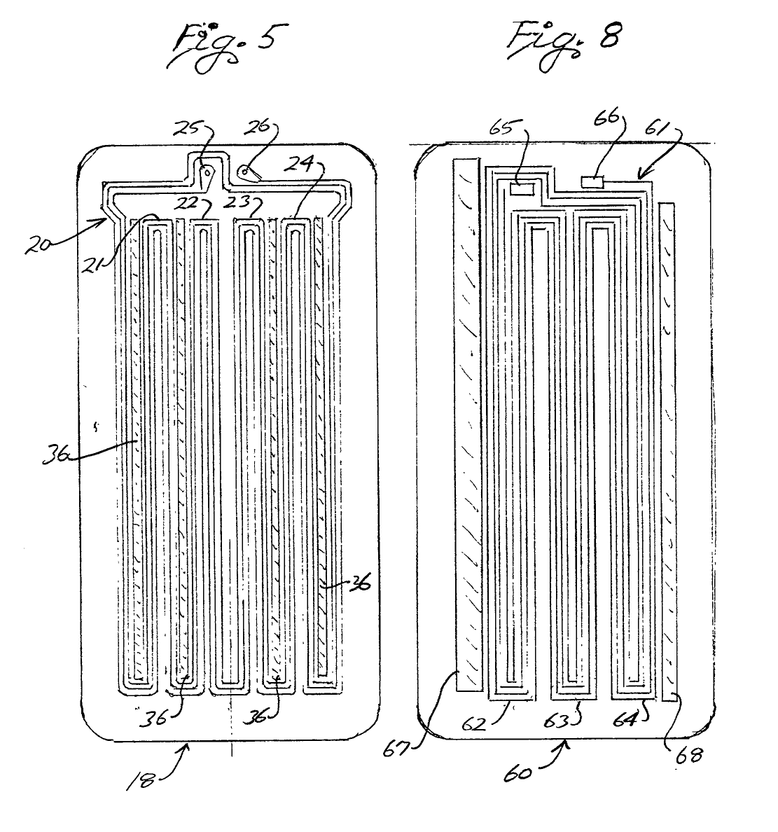

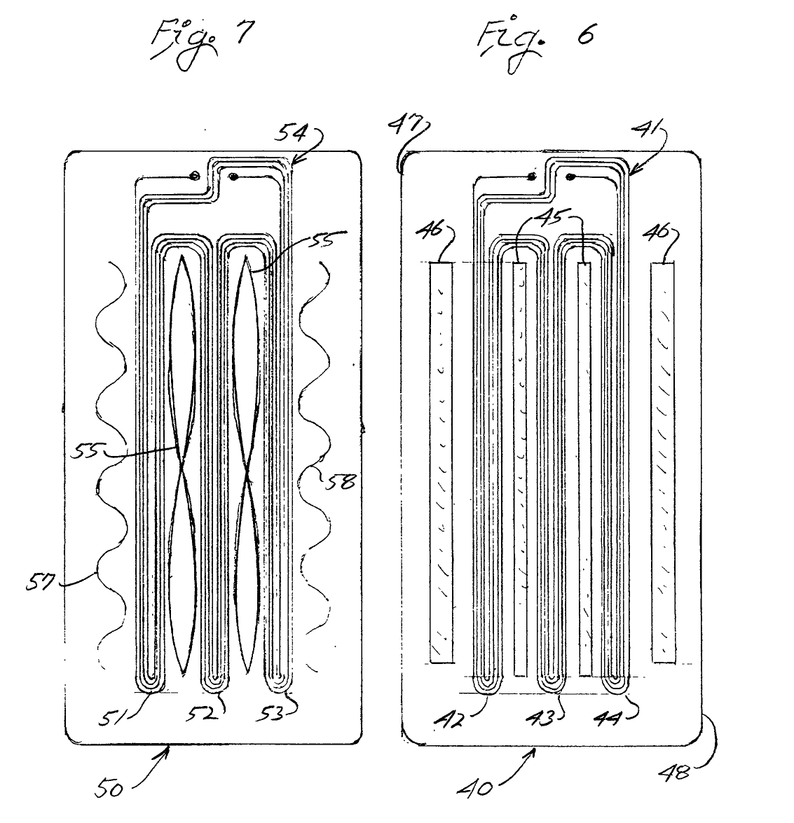

With reference to FIG. 6, a second embodiment of the invention is shown including a diaphragm 40 formed of a membrane/metallic laminate as previous discussed with respect to the embodiment of FIG. 5. The diaphragm includes an electrical circuit pattern 41 having a plurality of generally parallel branches 42-44 which are spaced relative to one another. In use, the branches are aligned with three rows of magnets as opposed to the four rows disclosed in FIG. 3. To control the modal behavior of the diaphragm 40, passive metallic strips or areas 45 are formed, such as previously discussed, intermediate the branches 42-44.

Also shown in FIG. 6 are outer passive strips or areas 46 which are formed generally parallel to the branches 42-44 and intermediate the branches and the side edges 47 and 48 of the diaphragm.

With specific reference to FIG. 7 a variation of the embodiment shown in FIG. 6 is disclosed. In this variation, the diaphragm 50 includes passive strips or areas which are shown as being asymmetrical with respect to branches 51-53 of an electrical circuit pattern 54. As shown, a pair of passive strip patterns 55 and 56 are shown spaced intermediate the branches of the electrical circuit pattern and are in the form of a double sinusoidal wave or an elongated FIG. 8. The asymmetrical metallic passive strips or areas cause a varied distribution of the mass relative to the electrical conductor circuit pattern. The variation in the placement and the mass will have an effect upon the modal response of the diaphragm especially in the mid-frequency range when the diaphragm is in use.

Also shown in the variation of FIG. 7 are outer passive strips 57 and 58 which are shown as being in the form of curved or sinusoidal waves. The passive strips 57 and 58 are thus asymmetrical with respect to vibrational modes generated by the interaction between the permanent magnets and the branches of the electrical circuit pattern which waves will extend outwardly perpendicular relative to the elongated axis of the conductor segments or branches.

With particular reference to FIG. 8, another embodiment of the invention is disclosed. In this embodiment, the diaphragm 60 is prepared as previously discussed so as to having an electrical circuit pattern 61 having three branches 62-64 defined by a plurality of conductor segments which are connected to an input 65 and an output 66. The diaphragm material is further treated to remove portions of the metallic layer of the laminate to create bordering metallic passive strips 67 and 68 which extend along opposite sides of the conductor pattern so as to be intermediate the conductor pattern and the side edges 69 and 70 of the diaphragm. In addition, passive strip 67 is shown as having a greater width and length dimension and therefore supplies a greater mass along the left side of the diaphragm than the smaller passive strip 68, as shown on the right side of the diaphragm. The sizes, configurations and shapes of the passive strips again may vary depending upon the configuration and size of the electrical circuit pattern. The specifics of the passive strips will be determined to provide smooth modal response for the transducer when in use in a mid-frequency range of 500 hz to 4 khz.

With specific reference to FIG. 9 a further embodiment of the present invention is disclosed. This variation includes a diaphragm 72 including an electrical conductor circuit pattern 73 including three branch segments 74-76 which are connected to an input 77 and an output 78. Positioned within the branch segments are passive strips 80 and 81 which are undulated. This configuration will also create asymmetrical balancing of the diaphragm relative to the generation of vibrational waves established in the diaphragm when a current is supplied through the electrical circuit pattern when the conductors are mounted within the magnetic field of the permanent magnets as previously described.

With particular reference to FIG. 10 a further embodiment of the present invention is shown including a diaphragm 82 which includes two separate electrical circuit patterns 84 and 85 which are formed on two separate areas 86 and 87 of the diaphragm. A passive metallic strip 88 extends the full length of the diaphragm so as to separate the two sections of the diaphragm which will have different vibrational characteristics. In the present embodiment, additional passive strips may be provided intermediate the branches of the electrical circuit patterns on each section of the diaphragm, if necessary, and as disclosed with respect to the previous embodiment discussed above. In this embodiment, the passive strip 88 will prevent modal interference of one section of the diaphragm relative to the other with the section of the diaphragm shown at 86 functioning in the mid-range of the diaphragm when in use and the portion of the diaphragm shown at 87 operating at a higher frequency range.

Again, it should be noted that the passive strips may have varying configuration and may be in the form of symmetrical or asymmetrical areas such as lines, dots, geometrical shapes and the like.

The foregoing description of the preferred embodiment of the invention has been presented to illustrate the principles of the invention and not to limit the invention to the particular embodiment illustrated. It is intended that the scope of the invention be defined by all of the embodiments encompassed within the following claims and their equivalents.

We claim:

1. A method of mass balancing planar acoustic transducer diaphragms to provide for modal control of the diaphragms during use, the method comprising:
providing a diaphragm material in the form of a laminate of a non-conductive membrane having a first metallic layer applied to at least one surface thereof; and
selectively treating the first metallic layer applied to the at least one surface to remove portions of the first metallic layer to form an electrical conductor circuit pattern and at least one passive metallic area which is spaced from the electrical conductor circuit pattern on the at least one surface of the membrane whereby the at least one passive metallic area provides a mass on said at least one surface of the diaphragm for balancing vibrational modes of the diaphragm during use.

2. The method of claim 1 wherein said electrical conductor circuit pattern and said at least one passive metallic area are substantially simultaneously formed during the treating of the first metallic layer.

3. The method of claim 1 in which the laminate includes a second metallic layer applied on a second surface of the membrane and treating the second metallic layer to remove portions of the second metallic layer to form at least one passive metallic area on the second surface of the membrane.

4. The method of claim 1 in which said treating includes coating selected surface portions of the metallic layer and subsequently chemically processing the first metallic layer to thereby remove portions of the first metallic layer other than the selected surface portions.

5. The method of claim 4 wherein said electrical conductor circuit pattern and said at least one passive metallic area are substantially simultaneously formed during the treating of the first metallic layer.

6. The method of claim 2 including forming the electrical conductor circuit pattern so as have a plurality of spaced branches, and forming a passive metallic area intermediate at least two of the plurality of the spaced branches.

7. The method of claim 6 including forming each of the passive metallic areas generally parallel to at least two of the plurality of the spaced branches.

8. The method of claim 7 including forming the plurality of spaced branches along a central portion of the diaphragm spaced inwardly relative to opposed side edges thereof, and forming an additional passive metallic area intermediate the plurality of spaced branches and each of the side edges of the diaphragm.

9. The method of claim 6 including forming each of the passive metallic areas asymmetrically with respect to the at least two spaced branches.

10. The method of claim 9 including forming the plurality of spaced branches along the central portion of the diaphragm spaced inward relative to opposed side edges thereof, and forming an additional passive metallic area intermediate the plurality of spaced branches and each of the side edges of the diaphragm.

11. The method of claim 10 including forming the additional passive metallic areas so as to be asymmetrical with respect to said plurality of spaced branches.

12. The method of claim 2 including forming the electrical conductor circuit patterns so as to have a plurality of spaced branches which are spaced inwardly of opposite side edges of the diaphragm, and forming a passive metallic area intermediate the spaced branches and the opposite side edges of the diaphragm.

13. The method of claim 2 including forming a plurality of spaced metallic passive areas on the at least one surface of the membrane.

14. The method of claim 13 including forming the plurality of metallic passive areas such that at least two of the metallic passive areas are of differing dimensions.

15. The method of claim 2 including removing portions of the first metallic layers to form at least two independent spaced electrical conductor circuit patterns on the at least one surface of the membrane and forming said at least one passive metallic area intermediate the at least two independent spaced electrical conductor circuits.

16. The method of claim 1 including selective treating the first metallic layer to remove portions of the first metallic layer to form at least two independent spaced electrical conductor circuit patterns on the at least one surface of the membrane and forming said at least one passive metallic area intermediate the at least two independent spaced electrical conductor circuits.

17. The method of claim 1 including selectively treating the first metallic layer to form an electrical conductor circuit pattern and at least one passive metallic area which are generally uniform in thickness relative to one another.

18. The method of claim 1 including selectively treating the first metallic layer to form an electrical conductor circuit pattern and at least one passive metallic area which are of differing thickness relative to one another.

19. The method of claim 1 including selectively treating the first metallic layer to form the at least one passive metallic area so as to have a non-uniform thickness.

20. A diaphragm for a planar magnetic transducer comprising, an electrical non-conducting membrane having opposite side edges, an electrical circuit pattern carried on a surface of said membrane, said electrical circuit pattern including a plurality of generally parallel branches, and passive areas carried on said surface of said membrane intermediate and spaced from at least two of said branches, whereby said passive metallic areas balance vibrational modes of the diaphragm during use.

21. The diaphragm of claim 20 in which said passive areas are asymmetrical relative to said branches.

22. The diaphragm of claim 21 includes additional passive areas carried on said surface of said membrane intermediate each of said opposite side edges and said electrical circuit pattern.

23. The diaphragm of claim 22 in which said additional passive areas are asymmetrical with respect to said branches.

24. The diagram of claim 22 in which said additional passive areas are of different configurations.

25. The diaphragm of claim 21 wherein said passive areas are formed of a metallic material.

26. The diaphragm of claim 20 in which said passive areas are of different configurations.

27. The diaphragm of claim 20 in which at least one of said passive areas includes undulated edge portions.

28. The diaphragm of claim 20 wherein said passive areas are formed of a metallic material.

29. The diaphragm of claim 28 in which said electrical circuit patterns and said passive areas are of uniform thickness relative to one another.

30. The diaphragm of claim 28 in which said electrical circuit pattern and said passive areas are of non-uniform thickness relative to one another.

31. The diaphragm of claim 28 wherein at least one of said passive areas is of non-uniform thickness.

32. A diaphragm for a planar magnetic transducer comprising, a laminate having an electrical non-conductive membrane layer and at least one metallic layer, said metallic layer consisting of at least one electrical circuit pattern and at least one passive metallic area, and said at least electrical circuit pattern and said at least one passive area being of non-uniform thickness relative to one another.

33. A diaphragm for a planar magnetic transducer comprising, a laminate having an electrical non-conductive membrane layer and at least one metallic layer, said metallic layer consisting of at least two independent electrical circuit patterns and a passive metallic area separating said at least two independent electrical circuit patterns from one another.
